(19) United States
(12) Patent Application Publication
(10) Pub. No.: US 2003/0221109 A1
(43) Pub. Date: Nov. 27, 2003

(54) Method of and apparatus for digital signatures

(75) Inventors: John Michael Boyer, Victoria (CA); Michael Cain Mansell, Victoria (CA)

Correspondence Address: GOWLING LAFLEUR HENDERSON, LLP, Suite 2600, 160 Elgin Street, Ottawa, ON, K1P 1C3, CA

(73) Assignee: Pure Edge Solutions, Inc.

(21) Appl. No.: 10/443,057

(22) Filed: May 22, 2003

Related U.S. Application Data
(60) Provisional application No. 60/382,881, filed on May 24, 2002.

(51) Int. Cl. H04L 9/00

(52) U.S. Cl. 713/176

(57) ABSTRACT

An improved digital signature method that maintains the secure signer and document authentication properties of a correct digital signature scheme and accounts for document longevity without introducing the complexities of an intricate public key infrastructure.

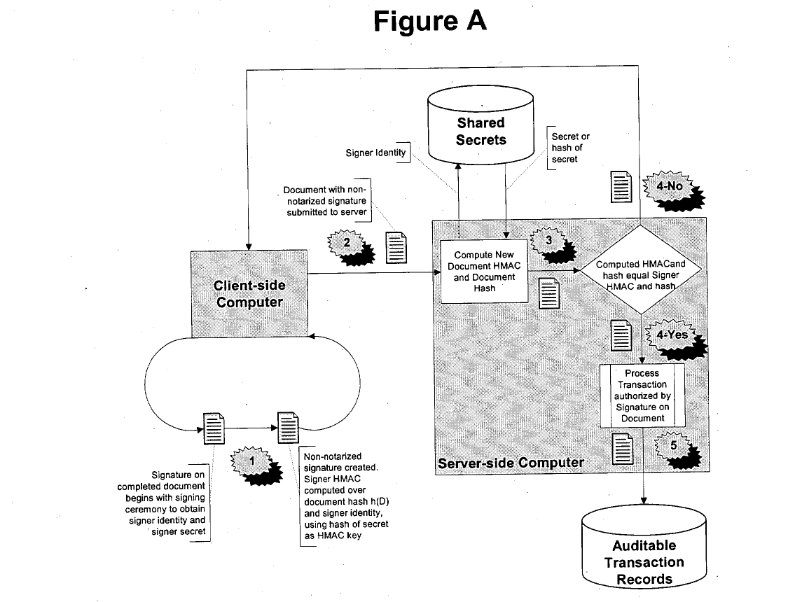

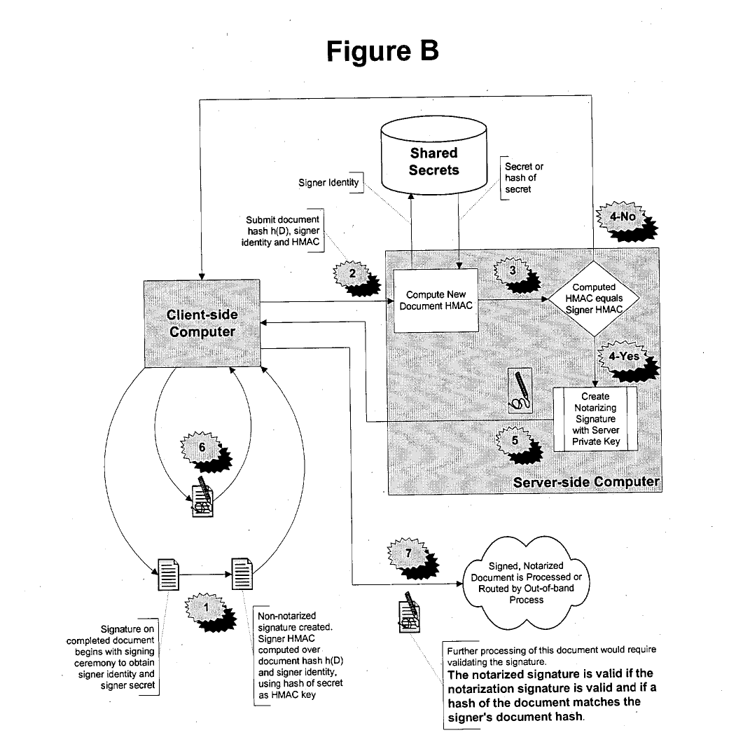

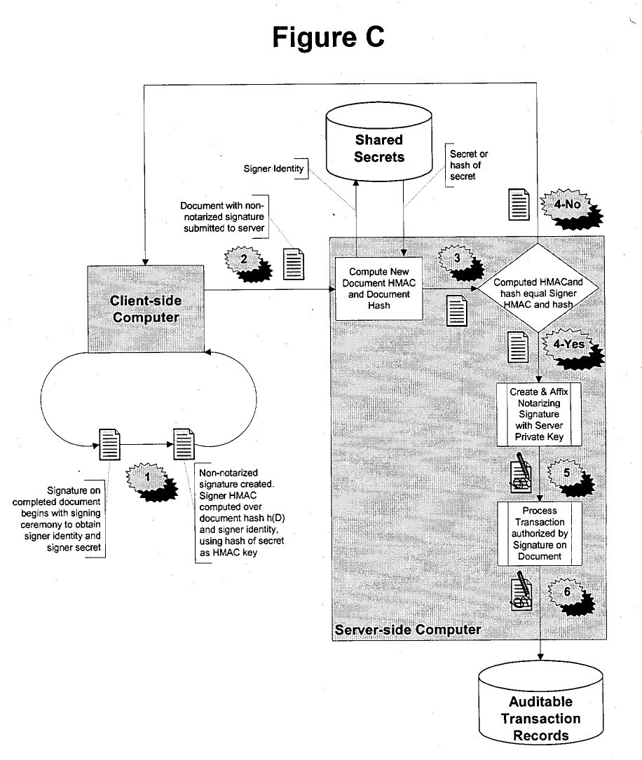

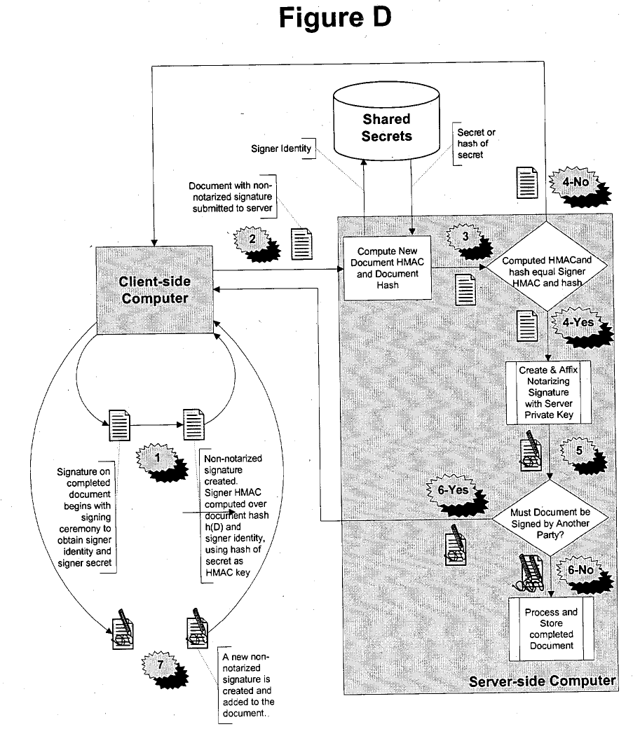

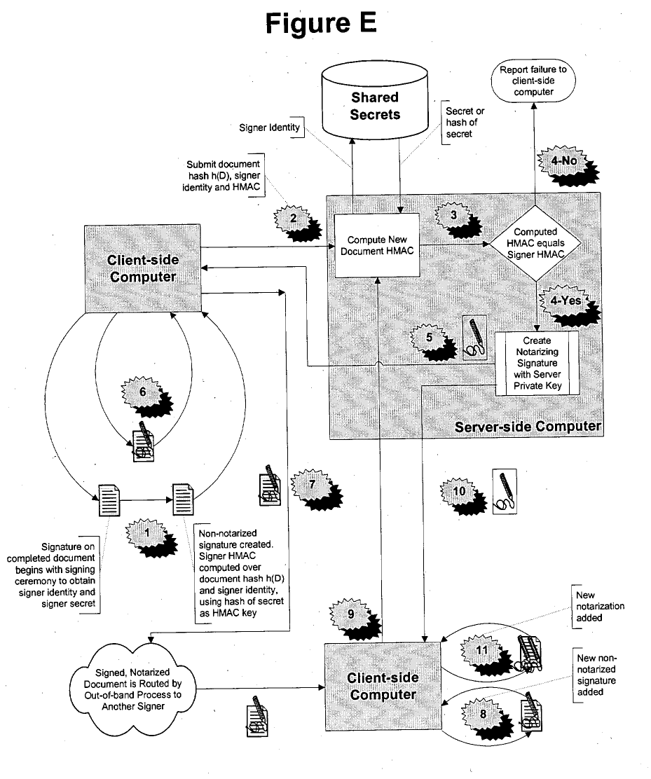

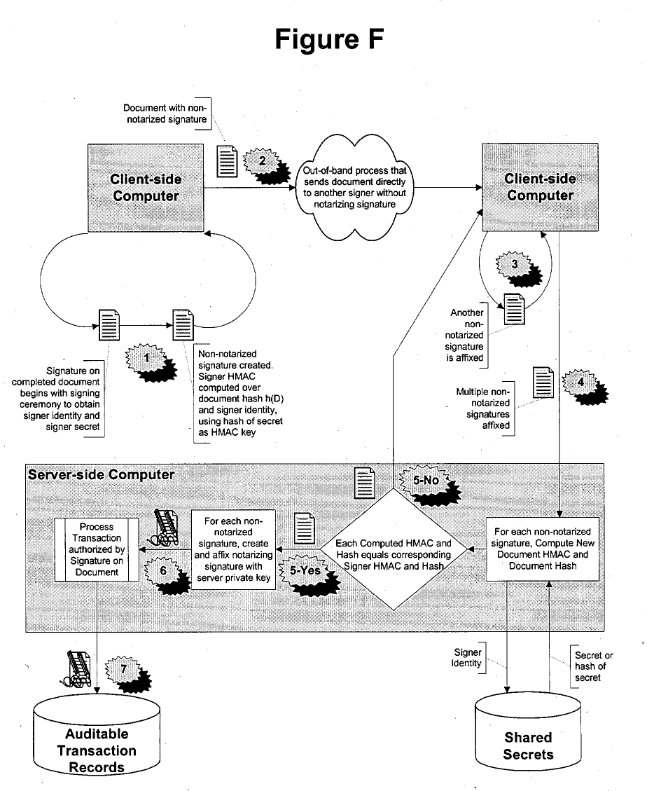

### FIELD OF THE INVENTION

The present invention relates to methods of creating digital signatures and is particularly concerned with authenticating both the signer and content of documents.

### BACKGROUND OF THE INVENTION

Every sequence of bits (binary 0 and 1 values) can be considered a document, so every document can be represented digitally as a sequence of bits. The bits are considered in subgroups that represent letters, numbers, marks of punctuation, digitized pictures and sounds and so forth. A digital signature is a sequence of bits whose purpose is to authenticate both the signer and content of a document (or some desired portion of a document). A digital signature can be associated with a document by adding it to the document or by some method external to the document.

In any digital signature discussion, there are three vantage points to consider: the signer, the verifier, and the attacker. The signer affixes a signature in order to associate himself/herself with the document content (e.g. to authorize the details of a transaction described by the document). The verifier uses the signature to determine that the document content has not been modified since the signature was affixed and to determine who affixed the signature. The attacker is a hypothetical entity that should not, under a correct digital signature scheme, be able to modify the document to which the signature is affixed nor the identity of the signer given by the signature.

Standard methods of authenticating document content are based in part on the existence of so-called “one-way” functions, which are also known as “hashing” functions. A hashing function operates over the sequence of bits representing the document to produce a unique “hash” value for the document. While it is theoretically possible for two documents to have the same hash value, one-way functions are constructed such that it is provably difficult to create a document that matches a given hash value (hence, the term one-way, since it is easy to produce a hash value given a document). Moreover, small changes to a document are guaranteed to produce a different hash value. Indeed, the computer security community typically deprecates the use of a hashing function when any two documents are ever found that have the same hash value.

The aforementioned properties of hashing functions are necessary for document content authentication but not sufficient. The hash value of the document content must also be immutable under a document content authentication scheme. To satisfy this requirement, the hash value is encoded. The current industry strategy is to use a public-key/private key encryption method such as RSA. The signer's private key is used to encode the document content hash value at the time of signing. The verifier uses the signer's public key to decode the hash value so that it can be compared against a newly computed hash of the document delivered to the verifier. The attacker cannot modify the document delivered to the verifier because the altered document's hash value will not match the one computed by the signer. The attacker also cannot change the hash value computed by the signer because the attacker does not have the private key, so it is impossible to re-encode the hash value of the altered document in such a way that the signer's public key will properly decode it.

In addition to securing the document authentication hash value, this strategy also implicitly authenticates the signer. The hash value computed by the signer can be decrypted for comparisons, but only the holder of the signer's private key can encrypt such a hash value in the first place. Thus, the signer's identity is bound by private key encryption to the document content.

Provided that the verifier can securely obtain the correct public key for the signer (and that the signer's private key has not been stolen), the above method is not assailable without finding some cryptographic weakness in the public key encryption scheme or the hashing function. No such weaknesses exist in the algorithms currently being deployed, so an attacker is forced to attack the scheme by which the signer's public key is delivered (or to steal the signer's private key, against which there is only physical defense). The current scheme for protecting public key delivery is the public key infrastructure.

In a public key infrastructure, an entity known as a certificate authority is responsible for authenticating any potential signers within the infrastructure prior to any signing events. Once a signer is authenticated, the certificate authority places the signer's identity and public key into a special document called a certificate, which is both issued and digitally signed by the certificate authority. To validate a signature within the infrastructure, the verifier first obtains the signer's public key certificate and uses the public key contained therein to decode and validate the signer's hash value against a newly computed hash value for the document. If this operation succeeds, the verifier then obtains the public key of the certificate authority and uses this to check the certificate authority's signature over the signer's public-key certificate. A successful result ensures that an attacker did not succeed at breaking the delivery of the signer's public key. Thus, the problem of public key delivery is reduced from securely delivering every signer's public key to securely delivering the certificate authority's public key to the verifier, which can be done by very secure and (hence) more costly means because it must only occur once for all signers in the certificate authority's domain whose signature must be validated by the verifier.

The notion of public key infrastructure has made the secure delivery of public keys feasible. However, a public key infrastructure still requires a great deal of effort to establish and maintain. In some domains, the cost and effort are justifiable, but in many cases it is excessive, which causes organizations to shy away from digital signature technologies altogether. Such organizations would prefer systems that are as easy to set up and maintain as the password or PIN (personal identification number) schemes they are currently using to authenticate their customers, and which do not encumber their users beyond the requirements of these simpler authentication schemes.

### SUMMARY OF THE INVENTION

The objective of the present invention is to provide an improved digital signature scheme.

Accordingly, the invention maintains the secure signer and document authentication properties of a correct digital signature scheme, but it does this without the complexities of establishing and maintaining an intricate public key infrastructure.

The above requirement, satisfied by the invention, is accomplished in part by utilizing a security scheme originally designed for authenticating server protocol messages outside of its normal domain of application. A hashed message authentication code (HMAC) is the result of a hashing calculation that combines a message with a shared secret in such a way that possession of the message and secret allows one to recreate the HMAC, but possession of the message and HMAC does not allow one to recreate the secret. Any method that performs this function is called an HMAC, though the technical details of the original, standard method of creating an HMAC appear in RFC 2104 (www.ietf.org/rfc/rfc2104.txt).

The typical application of the HMAC method has been authentication of server-to-server communications by more efficient means than symmetric key encryption. Before any communications occur, all servers in a system are provided with a shared secret. Any message from one server to another is accompanied by an HMAC so that the receiving server can validate that the message came from another server within the system rather than an outsider who may be attacking the system. Three key properties of this construction are 1) the participants are servers, 2) all participants are in possession of a common piece of information called a shared secret, and 3) the HMAC and typically the message are temporary (i.e. used and discarded immediately). These are not properties of the present invention.

In a second, more recent application of the HMAC method, a server shares a unique secret with each of many clients, and the server uses HMAC for access control to non-public resources. First, the server generates a random message and sends it to the client. Then, the client computes and returns an HMAC for the random message. Finally, the server ensures that the client-provided HMAC matches the HMAC that the server computes for random message given the secret for the specific client. A successful result authenticates the client-side user, which allows the server to grant to that user access to non-public resources. Two key properties of this construction are 1) the results are used for access control, so they are discarded almost immediately once the user is authenticated, and 2) the authentication of a message is peripheral to the application intent. These are not properties of the present invention.

Solving the digital signature problem requires concomitant signer and message authentication as well as accounting for the longevity of the message being signed. To achieve these ends, the present invention applies the HMAC method and possibly some public key cryptography, though the latter is performed without establishing a complex public key infrastructure.

In accordance with an aspect of the present invention (the authenticated click-wrap digital signature method), a signature over a document is created by a client-side request that the signer provide a pre-arranged secret, which is combined with the document to form an HMAC. When the document is submitted to a server for processing, it is assumed that the server is a central authority that also knows (i.e. shares) the secret of the signer. A server-side signature validation therefore consists of successfully replicating the HMAC result provided by the signer given the message provided by the signer and the pre-arranged secret. Once the signature has been validated, the server-side process can optionally affix a public-key digital signature over the document and the signer identity to ‘notarize’ the signature. Client-side validation of an authenticated click-wrap signature consists of performing a traditional public-key signature validation with the notarizing signature. On a successful validation, the client-side software would represent the signature as coming from the original signer and notarized by the server-side central authority.

For many business systems, the non-notarized (i.e. HMAC only) authenticated click-wrap digital signature is sufficient because only the server-side verifier must be convinced of the legitimacy of a document before taking some action on behalf of the signer. In other words, the server-side verifier is protected from third party attacks. The server-side verifier is not protected from a signer who repudiates a signature based on the fact that his/her signature could be forged by the server-side due to knowledge of the shared secret (the signer-as-attacker scenario). In this case, the server-side verifier is typically protected by the legal statutes governing common business practices. The repudiating signer must be able to show that it is reasonable for his/her transaction to have been singled out for tampering from among all the many transactions processed by the verifier using a stable business process.

In some business systems, the server-side verifier may act more like a neutral, trusted third party. The server-side verifier intercedes between the client-side sign and verify steps to affix a notarizing digital signature. Since the client-side validation is predicated on the success of a public-key signature that always originates from the same signer (the server-side entity), an intricate public-key infrastructure is not required. Instead, all signers must only be able to authenticate themselves to a server-side shared secret system. The efficacy of this approach arises from the simple fact that many organizations already have such a user authentication system in place (e.g. the secret could be the password or PIN used to access a bank account or line of credit, or the user's credit card number and expiry date, if such is already known to the server-side entity).

Finally, server-side notarization can also be a useful measure for signatures that are only expected to undergo server-side verification as well as in hybrid systems. Once the server-side validates the signer's HMAC, a server notarization stamp can be immediately applied, whether or not client-side verification is expected. If the signed document is then placed in storage for long-term auditability, a subsequent signer repudiation of the signature necessitates the claim that a server-side attacker had access not only to the long-term storage device and shared secret system but also the server-side private key material (which may be more stringently guarded). On the other hand, in hybrid system the signed document may be presented to a second signer before server-side processing commences. This scenario occurs frequently, e.g. signer/co-signer, signer/witness, and co-authorizing signatures. In such cases, the second signer can be assured of the identity of the first signer due to the intervening server-side notarization.

### BRIEF DESCRIPTION OF THE DRAWINGS

These and other features of the invention will become more apparent from the following description in which reference is made to the appended drawings, including:

FIG. A, which illustrates the basic processing model of a non-notarized authenticated click-wrap signature in accordance with an embodiment of the present invention;

FIG. B, which illustrates the basic processing model of notarizing an authenticated click-wrap signature in accordance with an embodiment of the present invention;

FIG. C, which illustrates an alternate processing model of notarizing an authenticated click-wrap signature in accordance with an embodiment of the present invention;

FIG. D, which illustrates a processing model for multiple authenticated click-wrap signatures in accordance with an embodiment of the present invention; and

FIG. E, which illustrates an alternate processing model for multiple authenticated click-wrap signatures in accordance with an embodiment of the present invention.

FIG. F, which illustrates a third processing model for multiple authenticated click-wrap signatures in accordance with an embodiment of the present invention.

### DETAILED DESCRIPTION OF THE PREFERRED EMBODIMENT

FIG. A illustrates the basic processing model of a non-notarized authenticated click-wrap signature. After a client-side user modifies a document as appropriate to his or her needs, the user initiates the process of affixing his or her signature, which begins with a click-wrap signing ceremony that requests information about the signer's identity and the secret information to be used in computing the HMAC. As shown in step A.1, the non-notarized signature is then affixed by computing the HMAC over the signer's identity and the document hash, using the hash of the secret information as the key material for the HMAC calculation. The preferred embodiment utilizes the HMAC formula presented in RFC 2104:

H(K′x or opad, H(K′x or ipad, M))

where H is a secure hashing function, M is the message to be signed (the signer identity plus the document hash), K′ is the HMAC keying material (the hash of the secret information) padded in the manner described in RFC 2104, and both opad and ipad are defined as in RFC 2104. The message M to be signed could be computed differently; but the preferred embodiment takes the hash of the desired portion of the document content. The unpadded keying material could be derived by any means from the secret information, though hashing it is preferred.

The client-side user is then able to perform step A.2 to submit the signed document to the server for processing. The server uses the signer identity information to retrieve the signer's secret information, then computes the document HMAC again. As shown in step A.3, the computed HMAC and document hash are compared to the ones provided by the signer. A failure of either comparison should result in returning the document to the user as shown in step A.4-No. Step A.4-Yes illustrates the result of a successful validation of the signer HMAC and document hash. The server-side processor has now authenticated the signer and the message, so the transaction described by the document can now take place, and the document can be placed with the server-side database of auditable transaction records as shown in step A.5.

FIG. B illustrates, the on-line processing model of a notarized authenticated click-wrap signature. Step B. 1 proceeds in the same manner as in step A.1, resulting in a document signed with the user's non-notarized authenticated click-wrap signature. In step B.2, the hash of the portion of the document signed, the signer's identity and the HMAC are submitted to the server for notarization. These items could be submitted by sending the entire document, but for efficiency only the three items of information are required under the preferred embodiment in which the HMAC covers a hash of the desired portion of the document (and the signer identity) rather than the actual desired portion of the document.

The server-side then uses the signer identity to obtain the signer's secret or a hash of the signer's secret. As shown in step B.3, the server-side uses the information representing the signer secret to recompute the HMAC. The recomputed HMAC is then compared for equality with the HMAC provided by the signer in step B.2. Inequality results in a failure, which is reported to the user in step B.4-No. If the HMAC test succeeds, as shown in step B.4-Yes, then a server notarization signature is created. The server notarization signature covers the signer identity and the document content hash provided by the signer. The server notarization signature is returned to the client-side in step B.5, which associates it with the originating authenticated click-wrap signature as shown in step B.6. Finally, in step B.7, the document including the notarized authenticated click-wrap signature can be sent abroad, either for server-side processing or to another client-side computer for further processing by another user. Validation of the notarized authenticated click-wrap signature consists of validating the server notarization signature and validating that the hash over the desired portion of the document content matches the hash stored in the authenticated click-wrap signature, which represents the desired portion of the document content at signing time.

FIG. C illustrates the off-line processing model of a notarized authenticated click-wrap signature. Step C.1 proceeds in the same manner as in step A.1. Steps C.2, C.3, and C.4-No are equivalent to steps A.2, A.3, and A.4-No, respectively. In step C.4-Yes, the non-notarized authenticated click-wrap signature has been successfully validated, so a server notarization signature is created in the same manner as step B.4-Yes and then associated with the authenticated click-wrap signature in the same manner as step B.6 (except that the association occurs on the server-side). The server-side processor has now notarized its authentication of the signer and the message, so the transaction described by the document can now take place, and the document can be placed with the server-side database of auditable transaction records as shown in step C.5 and C.6.

FIG. D illustrates the off-line processing model for multiple notarized authenticated click-wrap signatures. Steps D.1, D.2, D.3, D.4-No and D.4-Yes proceed in the same manner as in steps C.1, C.2, C.3, C.4-No and C.4-Yes, respectively. In step D.5, a document workflow process may decide that the document must be sent to another client-side user for further work and signing. If further work is required, then the document is sent to the client-side machine as shown in step D.6-Yes. In step D.7, the client-side user performs the additional work and affixes a new non-notarized signature. The server submission and server-side steps represented by steps D.2 through D.5 are reiterated for the new signature. Eventually, the document workflow process determines that the document is completed. At this point, step D.6-No depicts the document containing multiple notarized authenticated click-wrap signatures being sent for final transaction processing and long-term storage.

FIG. E illustrates the on-line processing model for multiple notarized authenticated click-wrap signatures. Steps E.1 through E.7 are identical to steps B.1 to B.7. The difference is that we assume that the final out-of-band process is a workflow agent which decides that the document must undergo further work and signing by another client-side user. Upon receipt of the document, the second client-side user validates the notarized authenticated click-wrap signature of the first signer in the manner described above for step B.7. Then, after performing the additional work on the document, the user adds a second authenticated click-wrap signature in step E.8, then initiates the process of having that signature notarized in step E.9. This results in the creation of a notarization signature in steps E.3 and E.4-Yes (the failure at step E.4-No would obviously be routed to the client that actually submitted the request). The notarization signature is returned to the client-side in step E.10, where it is associated with the second authenticated click-wrap signature in step E.11.

FIG. F illustrates the out-of-band processing model for multiple notarized authenticated click-wrap signatures. Step F.1 proceeds in the same manner as in step A.1, resulting in a document signed with the user's non-notarized authenticated click-wrap signature. An out-of-band process (e.g. a workflow agent) is then used to route the document to a second client-side computer. The second client-side user is unable to validate the non-notarized authenticated click-wrap signature affixed by the first signer. Assuming the signature to be correct, the second user performs the additional work necessary and affixes a second non-notarized authenticated click-wrap signature in step F.3. The second user then submits the completed document for notarization and final processing in step F.4. The server-side performs a validation for each non-notarized authenticated click-wrap signature in the document. If the HMAC validation fails or the check of the hash over the desired portion of the document fails for any of the non-notarized signatures, then the erroneous document is returned to the second client-side user in step F.5-No. Otherwise, step F.5-Yes creates and affixes a server notarization signature for each of the non-notarized authenticated click-wrap signatures. Finally, steps F.6 and F.7 depict the completed document containing multiple notarized authenticated click-wrap signatures being sent for final transaction processing and long-term storage.

What is claimed is:

1. A method of digitally signing documents in which an ‘authenticated click-wrap digital signature’ contains an HMAC that securely combines information representing a signer's secret information with information representing the signer identity and information representing a desired portion of the document content, server-side validation of an authenticated click-wrap digital signature comprising the steps of
i. using the information representing the signer identity to help obtain the information representing the signer's secret,
ii. obtaining, the information representing the desired portion of the document content and verifying that this information is equal to the document content information provided by the signer,
iii. computing a new HMAC using the signer identity, the information representing the signer's secret, and the information representing the desired portion of the document, and
iv. testing for equality between the newly computed HMAC and the HMAC provided by the signer.

2. A method of creating a notarized authenticated click-wrap signature using the method of claim 1 to generate the authenticated click-wrap signature and further comprising the step of signature validation by performing a cryptographic validation of the notarization signature and testing for equality between the information representing the desired portion of the document content and the information in the authenticated click-wrap signature that represents the portion of the document content that was covered by the authenticated click-wrap signature at signing time.

3. A method as claimed in claims 2 wherein that notarization signatures are affixed to the document in such a way that, for all authenticated click-wrap signatures, all notarization signatures are excluded from the information representing the desired portion of the document content such that notarization signatures can be added, replaced or deleted without causing validation failures of any other signatures in the document.

4. A method as claimed in claims 1 wherein that notarization signatures are affixed to the document in such a way that, for all authenticated click-wrap signatures, all notarization signatures are excluded from the information representing the desired portion of the document content such that notarization signatures can be added, replaced or deleted without causing validation failures of any other signatures in the document.

5. A method of creating a server notarization signature for an authenticated click-wrap signature comprising the steps of
i. using the information representing a signer identity to help obtain information representing a signer's secret,
ii. computing a new HMAC using the signer identity, the information representing the signer's secret, and information representing a desired portion of a document,
iii. testing for equality between the newly computed HMAC and a HMAC provided by the signer, and
iv. if the test in iii is successful, use asymmetric key cryptography to generate a server-side digital signature covering the information representing the signer's identity and the information representing the desired portion of the document,
whereby the notarization signature is associated with the authenticated click-wrap signature, ‘notarizing’ the association between the signer identity and the portion of the document content covered by the authenticated click-wrap signature.

6. A method of creating a notarized authenticated click-wrap signature using the method of claim 5 to generate the server notarization signature, and further comprising the step of signature validation by performing a cryptographic validation of the notarization signature and testing for equality between the information representing the desired portion of the document content and the information in the authenticated click-wrap signature that represents the portion of the document content that was covered by the authenticated click-wrap signature at signing time.

7. A method as claimed in claims 6 wherein that notarization signatures are affixed to the document in such a way that, for all authenticated click-wrap signatures, all notarization signatures are excluded from the information representing the desired portion of the document content such that notarization signatures can be added, replaced or deleted without causing validation failures of any other signatures in the document.

8. A method as claimed in claims 5 wherein that notarization signatures are affixed to the document in such a way that, for all authenticated click-wrap signatures, all notarization signatures are excluded from the information representing the desired portion of the document content such that notarization signatures can be added, replaced or deleted without causing validation failures of any other signatures in the document.
